(19) United States
(12) Patent Application Publication
(10) Pub. No.: US 2017/0341830 A1
(43) Pub. Date: Nov. 30, 2017

(54) METHOD AND ASSEMBLY FOR MEASURING FLUID LEVEL IN A BEVERAGE CONTAINER USING ACOUSTIC RESONANCE MEASUREMENT DEVICE

(71) Applicant: Pacific Market International, LLC, Seattle, WA (US)

(72) Inventors: Wataru Nishizawa, Maple Valley, WA (US); Brian W. Read, Brier, WA (US); John M. Havard, Seattle, WA (US); Christopher B. Harrison, Vashon, WA (US); Paul H. Wierenga, Seattle, WA (US)

(21) Appl. No.: 15/605,727

(22) Filed: May 25, 2017

Related U.S. Application Data
(60) Provisional application No. 62/343,694, filed on May 31, 2016.

(51) Int. Cl. B65D 51/24; G01F 23/296; G01S 7/536; G01S 15/32

(52) U.S. Cl. CPC B65D 51/24; G01S 15/32; G01F 23/2967; G01S 7/536

(57) ABSTRACT

A method and beverage container assembly for determining a level of liquid in a beverage container having a lid removably attached thereto. The beverage container assembly including a sensor configured to measure sound waves in the beverage container assembly. A processor is electronically coupled to the sensor, and to memory provided with executable instructions for causing the processor to determine the level of liquid. The executable instructions, when executed by the processor, cause the processor to receive a sound wave measurement from the sensor, obtain a frequency characteristic of the sound wave measurement, and obtain reference information regarding a set of characteristics of the beverage container assembly. The processor may determine the level of liquid in the beverage container assembly based on the frequency characteristic and the reference information.

### FIELD OF INVENTION

The present invention relates to devices and methods for measuring a fluid level of a fluid in a beverage container.

### BRIEF DESCRIPTION OF THE DRAWINGS

FIG. 1 illustrates a cross-sectional view of a beverage container assembly having an acoustic resonance measurement device.

FIG. 2 illustrates an enlarged semi-transparent view of a beverage container lid having the acoustic resonance measurement device of FIG. 1.

FIG. 3A illustrates a schematic view of an electronics assembly of the acoustic resonance measurement device of FIG. 2.

FIG. 3B illustrates a first schematic view of an electronic system of the electronics assembly of FIG. 3A.

FIG. 3C illustrates a second schematic view of an electronic system of the electronics assembly of FIG. 3A.

FIG. 4 illustrates a flowchart for determining fluid level in the beverage container of FIG. 1.

FIG. 5 illustrates a power spectral density graph of an audio signal measured in the beverage container of FIG. 1.

### DETAILED DESCRIPTION

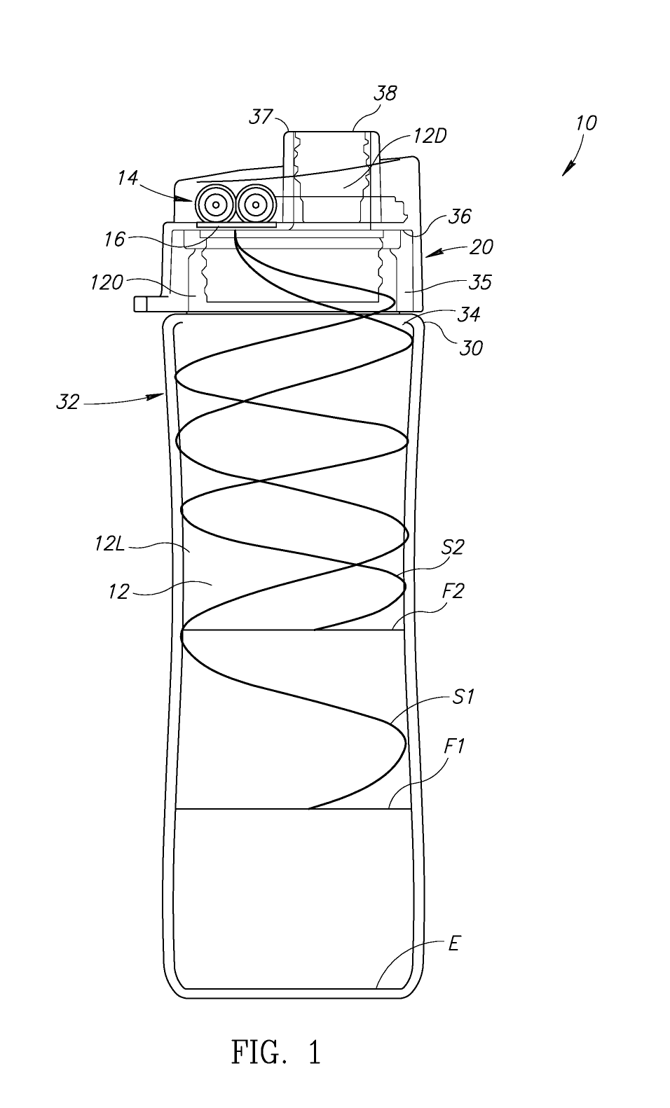

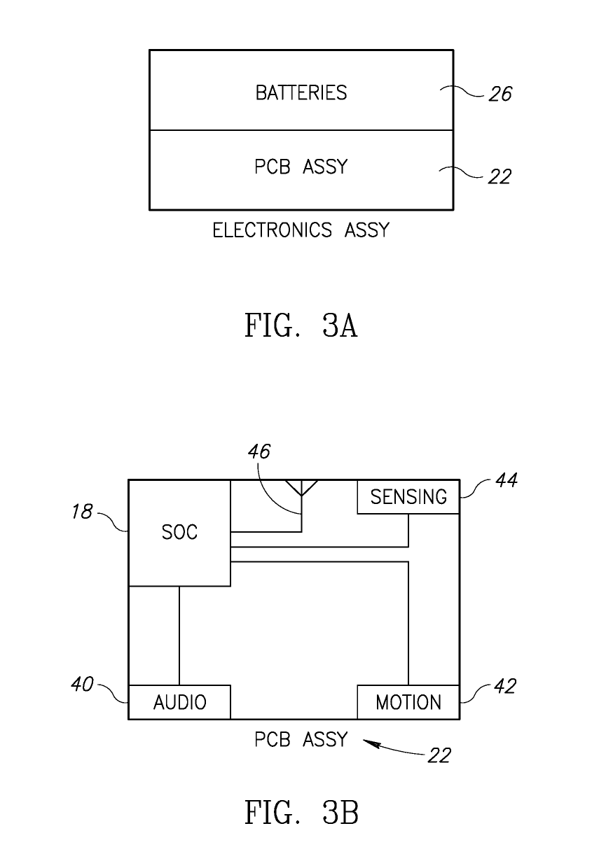

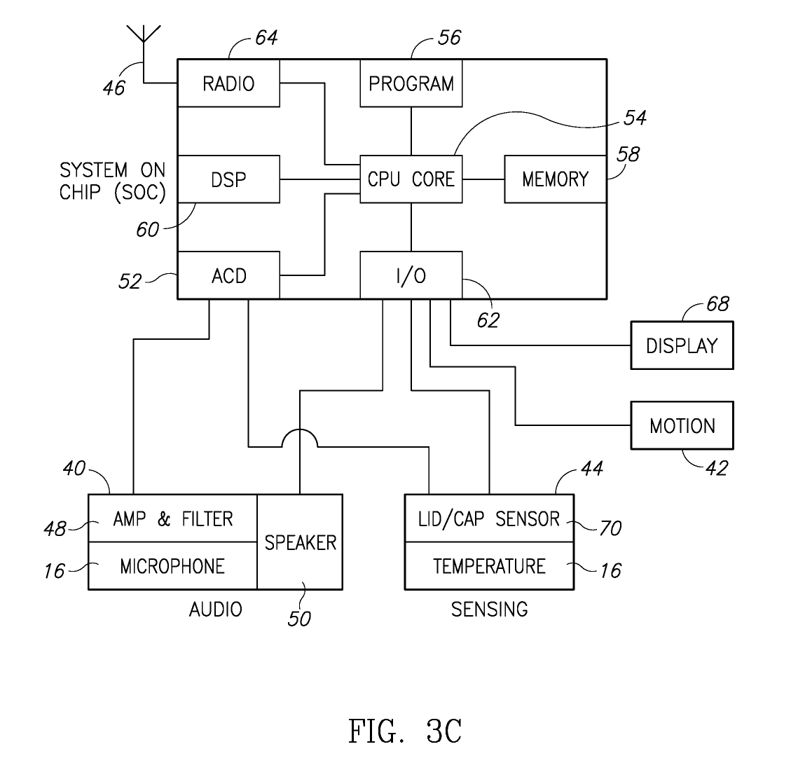

A beverage container assembly 10 configured to measure a fluid level of fluid in a beverage cavity 12 using a fluid measurement device 14 is shown in FIG. 1. The fluid measurement device 14 includes an acoustic sensor 16 (e.g., a microphone) configured to measure sound waves in the beverage cavity 12, and an electronic system 18 (see FIGS. 3A, 3B and 3C) that records the measured sound waves and performs an analysis regarding the measured sound waves to determine the fluid level of the fluid in the beverage cavity. The electronic system 18 may use Helmholtz resonance to identify frequency characteristics of the measured sound waves, which correspond to the fluid level of the beverage cavity 12. Based on results of the analysis, the electronic system 18 may notify a user regarding the fluid level of the beverage cavity 12.

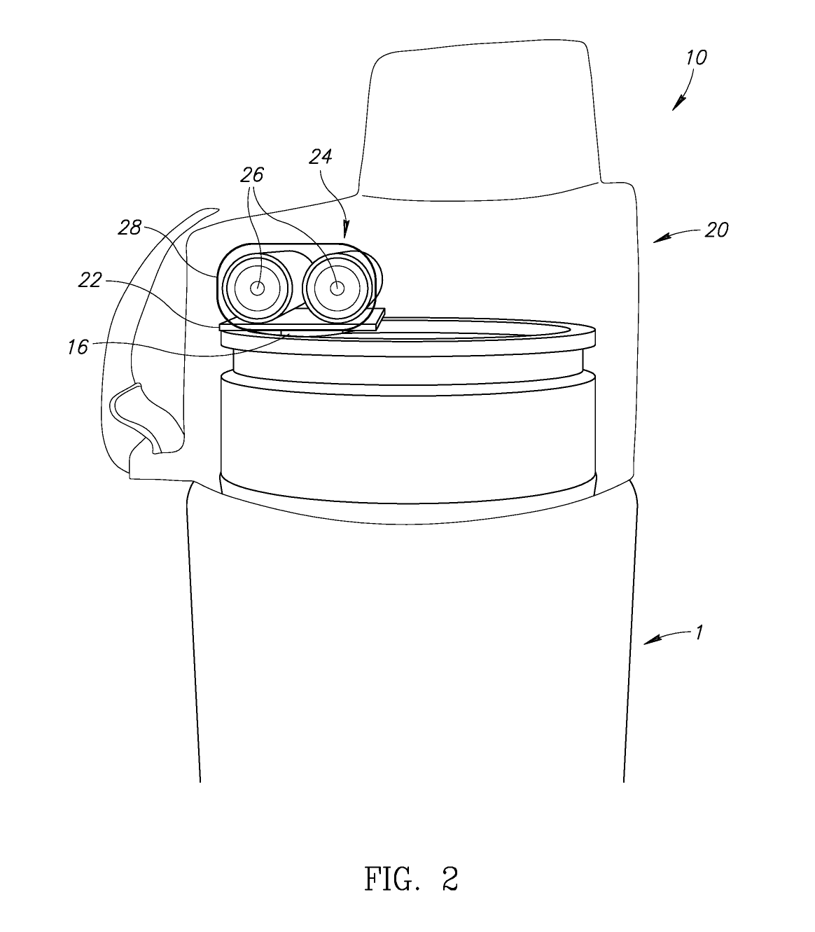

The acoustic sensor 16 in the electronic system 18 of the present embodiment is housed in a lid 20 of the beverage container 10, as shown in FIG. 2. The lid 20 may house a printed circuit board assembly (PCB) 22 on which the electronic system 18 and/or the acoustic sensor 16 are located. The acoustic sensor 16 is electronically coupled to the electronic system 18, and may be positioned on or adjacent to the PCB 22. The lid 20 may house an energy storage device, such as batteries 26, electronically coupled to the PCB 22 (see FIG. 3A) for powering the acoustic sensor 16 and the electronic system 18. The lid 20 may include a cavity 24 for housing the batteries 26 that may be inserted into or removed from the cavity through a battery door 28. Alternatively, the lid 20 may include a sealed internal energy storage device for powering the acoustic sensor 16 in the electronic system 18, and which is rechargeable through a port (e.g., micro-USB port) on the lid.

The lid 20 is removably attachable to an upper portion 30 of the beverage container main body 32. The beverage cavity 12 may include a cavity lower portion 12L extending downwardly from an aperture 34 at the upper portion 30, a cavity upper portion 12U in the lid 20 defined by a lid sidewall 35 extending downwardly from a lid upper portion 36, and a drinking aperture cavity 12D extending downwardly from a drinking aperture 38 to the lid upper portion 36. The lid 20 may include a cap 37 attached thereto for selectively sealing and unsealing the drinking aperture 38. The acoustic sensor 16 of the present embodiment is positioned facing downwardly toward the beverage cavity 12 on or in the lid upper portion 36 and directed to measure sound waves in the beverage cavity. Other positions for the acoustic sensor 16 are contemplated, however, such as on an inner side of the lid sidewall 35 or a sidewall of the beverage container main body 32. A thin membrane 39, such as a thin silicone rubber sheet, may cover the acoustic sensor 16 to protect the acoustic sensor and electronics from fluid ingress. The thin membrane 39 should have a low acoustic impedance such that its presence will not significantly affect the sound waves arriving at the acoustic sensor 16.

The acoustic sensor 16 generates an electronic audio signal corresponding to the sound waves measured in the beverage cavity 12. The electronic system 18 may analyze the audio signal to determine one or more characteristics of the audio signal. In particular, the electronic system 18 may perform a frequency domain conversion, such as a Fourier transform (e.g. Fast Fourier Transform (FFT)), to convert the time domain audio signal to the frequency domain and thereby produce a frequency spectrum corresponding to frequency components of sound within the beverage cavity 12. The electronic system 18 may further determine the power spectral density of the frequency spectrum of the sound within the beverage cavity 12. The power spectral density will exhibit a resonant frequency corresponding to the fluid level in the beverage cavity 12. Using the principle of Helmholtz Resonance, the fluid level of the fluid within the beverage container 10 may be accurately determined based on the resonant frequency and known characteristics of the beverage container, as described below. The electronic component 18 may notify the user of the fluid level and/or track the fluid level over time.

In addition to the electronic system 18, the PCB 22 may include an audio system component 40, a motion sensing system component 42, a supplementary sensing system component 44, and an antenna 46, as shown in FIG. 3B. The audio system component 40 may include a signal conditioning component 48 for filtering, amplifying or attenuating the audio signal from the acoustic sensor 16 before transmission to the electronic system 18. For example, the signal conditioning component 48 may include a low-pass filter (LPF) that filters out (i.e., attenuates) frequency components less than 2 kHz. The beverage container 10 of the present embodiment measures ambient sound in the beverage cavity 12 (i.e., sound produced by air passing into and out of the beverage cavity) without actively generating sound. In some embodiments, however, the audio system component may include a sound generating unit 50, as described below.

The electronic system 18 may include an analog-to-digital converter (ADC) 52 that samples and/or converts the analog audio signal received from the audio system component 40 into a digital audio signal. A processing unit 54 receives and processes the digital audio signal from the ADC 52 to determine the one or more characteristics of the audio signal. The processing unit 54 may be an integrated circuit (IC), such as a field-programmable gate array (FPGA) or application-specific integrated circuit (ASIC), or a processor (e.g., microprocessor), or a part thereof, configured to analyze the digital audio signal according to a predetermined method and generate a notification to the user corresponding to the results of the analysis. The processing unit 54 may execute instructions stored in program storage section 56 (e.g., ROM, RAM, cache) causing the processing unit to perform the analysis and generate the notifications described herein. The program storage section 56 may store a program for detecting the peak frequency in the power spectrum. The processing unit 54 may be electronically coupled to memory 58 (e.g., ROM, RAM, cache) for storing data related to the audio signal. The memory 58 may additionally store other data, such as reference data (e.g., look-up tables, calibration curve) related to the size and/or shape of the beverage cavity 12, calibration data for calibrating the beverage container 10, control data for controlling or communicating with electronic components connected to the processing unit, and/or storing a plurality of audio signal measurements for averaging received audio signals.

The processing unit 54 may also be electronically coupled to a digital signal processor (DSP) 60 for processing the received digital audio signal. The processing unit 54 may send digital audio signal data and a control signal to the DSP 60 causing it to perform one or more processes for reducing the load on the processing unit 54. In response to receiving the control signal or digital audio signal data, the DSP 60 may be configured to perform one or more processes for processing or analyzing the received digital audio signal data. The DSP 60 may be configured to perform a Fourier transform (e.g., FFT) converting the digital audio signal data from the time domain to the frequency domain. The DSP 60 may also be configured to detect the peak frequency in the power spectrum of the frequency spectrum of the digital audio signal data, and/or average several digital audio signal samples to improve signal-to-noise ratio (SNR).

The processing unit 54 may be electronically coupled to an I/O port 62 that connects to one or more peripheral devices, including the sound generation unit 50, the motion sensing system component 42, and/or the supplemental sensing system component 44. Other peripheral devices are contemplated, such a display device for notifying the user of the fluid level in the beverage cavity 12, amount of fluid consumed from the beverage cavity in a given time period, temperature of the fluid in the beverage cavity, or status of the lid 20.

The processing unit 54 may be electronically coupled to a wireless communication unit 64 configured for wirelessly communicating with other electronic devices, such as a smart phone, smart watch, or tablet computer, using the antenna 46. The communication unit 64 may be short-range or medium-range communication device, and may include one or more of a Bluetooth transceiver, a radio frequency transceiver, a Zigbee transceiver, an infrared transceiver, or a Wi-Fi transceiver, by way of non-limiting example. The communication unit 64 may receive data from the processing unit 54 related to the measured audio signal and transmit the data to a wirelessly connected electronic device according to a communication protocol. For example, the communication unit 64 may receive data regarding the results of the analysis, the fluid level of the beverage cavity 12, or the temperature of the fluid in the beverage cavity, and transmit the data to the user's smart phone using Bluetooth communication technology. The communication unit 64 may also be configured to receive data or commands from a wirelessly connected electronic device and send the received data or commands to the processing unit 54.

The electronic system 18, or components thereof, may be implemented as a system on chip or system in package design, or may be a plurality of discrete components on the PCB 22. One or more components of the audio system component 40, the motion sensing system component 42, and/or the supplemental sensing system component 44 may be a part of the electronic system 18.

The sound waves measured by the acoustic sensor 16 have a tone or frequency spectrum corresponding to a resonance characteristic of the beverage container 10. Specifically, when the drinking aperture 38 is unsealed (i.e., the cap 37 is removed from the drinking aperture 38), the beverage cavity 12 produces sound waves with a particular resonant frequency f_{R}. Outside ambient noise may enter the beverage container 10 and couple to resonant modes inside the beverage container according to Helmholtz resonance. The resonant frequency f_{R} produced in the beverage cavity 12 depends on the air volume inside the beverage cavity 12, the speed of sound in the beverage cavity 12, the length of the drinking aperture cavity stop 12D, and the cross-sectional area of the drinking aperture cavity 12D. Referring to FIG. 1, the resonance frequency f_{R} of a beverage cavity 12 having known dimensions and with an open drinking aperture 38 may be calculated using Equation (1), where v_{S} is the speed of sound, A is the cross-sectional area of the drinking aperture cavity 12D, V is the volume of air in the cavity lower portion 12L and the cavity upper portion 12U, and L is the length of the drinking aperture cavity 12D.

$${f}_{R} = \frac{{v}_{S}}{2 π} \sqrt{\frac{A}{VL}} \qquad ( 1 )$$

When the fluid level of the beverage container 10 is full, the volume V of the beverage cavity 12 is at a minimum (i.e., volume of air in the lower beverage cavity 12L is approximately zero) and the resonant frequency f_{R} exhibited is a maximum frequency f_{RF} for the particular beverage cavity. Conversely, when the beverage container 10 is empty, the volume V of the beverage cavity 12 is at a maximum and the resonance frequency f_{R} exhibited is a minimum frequency f_{RE} for the particular beverage cavity. As the fluid level in the beverage container 10 decreases, the volume V of air in the beverage cavity 12 increases and the resonance frequency f_{R} will decrease from the maximum resonance frequency f_{RF}. For example, when the beverage cavity 12 is filled to a fluid level F1 (see FIG. 1), the beverage cavity will exhibit a first resonant tone T1 having a first resonance frequency f_{R1} lower than the maximum resonance frequency f_{RF}, and higher than the minimum resonance frequency (i.e., frequency when the beverage cavity 12 is empty). When the beverage cavity 12 is filled to a fluid level F2 greater than the fluid level F1, the beverage cavity will exhibit a resonant tone T2 having frequency f_{R2} higher than the first resonance frequency f_{R1}.

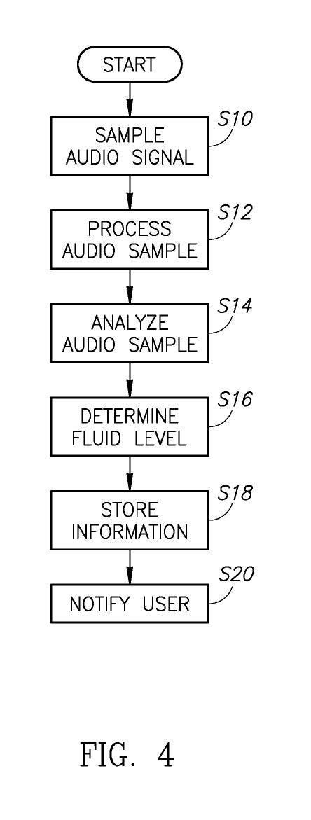

To determine the fluid level of the fluid in the beverage cavity 12, the electronic system 18 samples the audio signal from the acoustic sensor 16, processes the sampled audio signal into the frequency domain, and performs an analysis on the frequency domain signal to determine its resonant frequency. A process of determining the fluid level of the beverage container 10 is shown in FIG. 4. In step S10, the electronic system 18 receives a measured audio signal from the audio sensor 16. The processing unit 54 may control the ADC 52 to sample the audio signal from the acoustic sensor 16 and then send a digitally-sampled audio signal to the processing unit. The ADC 52 should sample the audio signal for a sufficient time to capture a frequency spectrum appropriate to the size of the beverage container 10. For example, a beverage container 10 having a resonance frequency band from 100 Hz to 1 kHz should sample the audio signal for at least 10 ms. The processing unit 54 may control the ADC 52 to sample the audio signal in response to a stimulus or according to a sampling schedule to appropriately manage or conserve power, as described below.

In step S12, the electronic system 18 processes the audio signal sample and converts the audio signal from the time domain to the frequency domain. The processing unit 54 or the DSP 60, which is controlled by the processing unit, may perform a Fourier transform (e.g., FFT, discrete Fourier Transform (DFT)) on the received time-domain audio signal, converting it into a frequency-domain audio signal having a frequency spectrum. Other frequency-domain conversions are contemplated, such as a Laplace transform or a Z-transform.

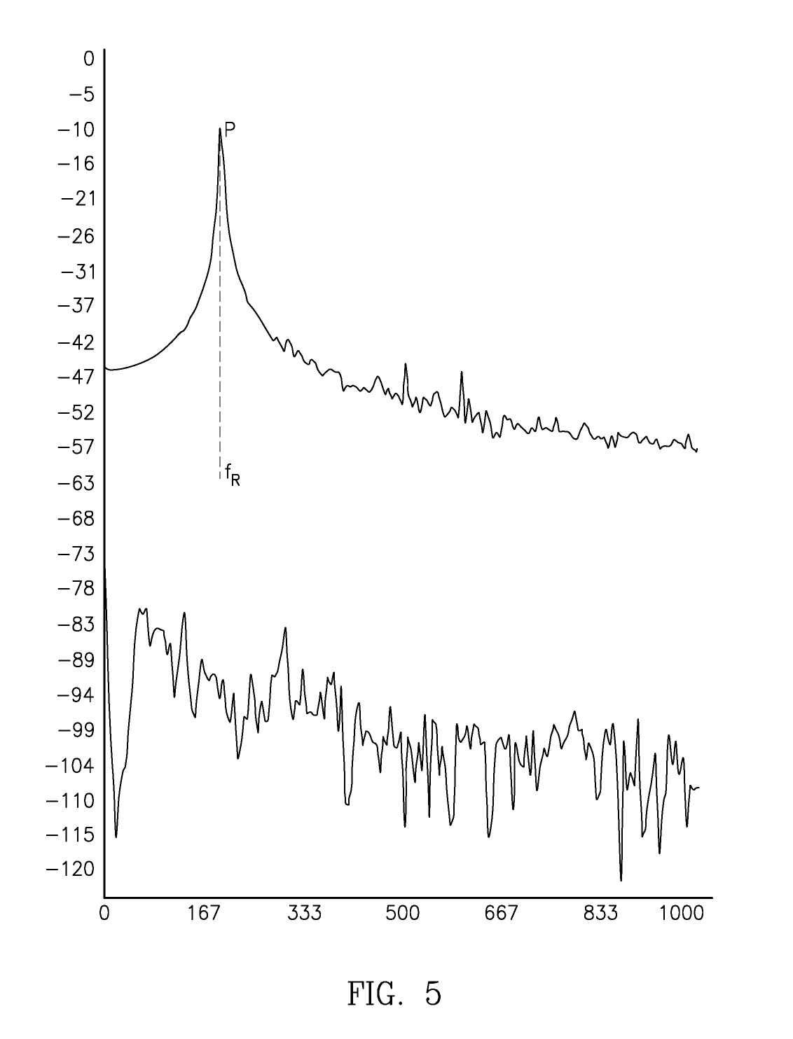

The electronic system 18 then analyzes the frequency-domain audio signal in step S14 to determine the resonant frequency f_{R} of air in the beverage cavity 12. Based on the Helmholtz resonance principle described above, the frequency-domain audio signal has a peak P corresponding to the resonant frequency f_{R} of the air in the beverage cavity 12, as shown in FIG. 5. The processing unit 54 or the DSP 60 may analyze the power spectral density of the frequency-domain audio signal to determine the frequency of the peak P. The peak detection of step S14 may be implemented by executing software stored in the program memory 56 or using hardware configured to detect the peak P, such as an FPGA.

In step S16, the electronic system 18 determines the fluid level in the beverage cavity 12 based on the resonant frequency f_{R} at the detected peak P and the known dimensions of the beverage cavity. Specifically, the resonant frequency f_{R} corresponds to a volume of air contained in the beverage cavity 12. The processing unit 54 may reference a lookup table on the memory 58 that identifies the cross-sectional area A of the drinking aperture cavity 12D, the volume of air of the cavity upper portion 12U, the length L of the drinking aperture cavity 12D, the cross-sectional area A_{L} of the cavity lower portion 12L, and the volume of air V_{E} when the beverage cavity 12 is empty (i.e., does not have fluid). From this data, the processing unit 54 may determine the current volume of air V in the cavity lower portion 12L using Equation 1. The fluid level F may then be calculated by subtracting the current volume of air V from the empty cavity volume of air V_{E}, and then dividing the result by the cross-sectional area A_{L}. Alternatively, the processing unit 54 may reference a calibration curve or chart, stored on the memory 58, that defines one or more curves indicating a fluid level corresponding to a determined resonance frequency f_{R}.

The speed of sound v_{S} of air in the beverage cavity 12 is dependent upon the temperature of the air therein. The electronic system 18 may measure the temperature of the fluid or air in the beverage cavity to calculate the temperature-adjusted speed of sound v_{S} and accurately determine the fluid level F. The PCB 22 in the lid 20 may be equipped with a temperature sensor 66 positioned at or in the upper beverage cavity 12U for measuring the temperature of the air therein. The ADC 52 may be electronically coupled to the temperature sensor 66 and configured to sample temperature measurements from the sensor and transmit a digital signal corresponding to the temperature measurements. Prior to step S16 (e.g., in step S10), the processing unit 54 may control the ADC 52 to acquire one or more temperature measurements from the temperature sensor 66. The processing unit 54 may process the temperature measurements and adjust the speed of sound v_{S} based on the temperature measurement. For example, the processing unit 54 may generate a correction coefficient or identify a correction coefficient stored in the memory 58 to calculate or identify the resonance frequency f_{R}.

The resonant frequency f_{R} of the air volume in the beverage cavity 12 may be used to calculate or identify the fluid level F or volume of fluid in the beverage cavity based on a calibration curve. The identified resonant frequency f_{R} may correspond to a fluid level F or volume of fluid on the calibration curve. Different calibration curves may be established for beverage containers having different shapes and/or sizes. The calibration curve may vary from pure Helmholtz theory based on the specific geometry of the lid or other real-world considerations, such as types of material used in the beverage container. Calibration curve data may be stored in the memory 58 or in a mobile application stored in the user's mobile device.

In step S20, the electronic system 18 notifies the user of the fluid level F or the volume of fluid in the beverage cavity 12. The processing unit 54 may control the communication unit 64 to wirelessly transmit data relating to the resonant frequency f_{R} or the fluid level F to the user's mobile device that is equipped with an application for notifying the user of the fluid level F. Alternatively, the processing unit 54 may display the fluid level F or volume of fluid in the beverage cavity 12 on a display device 68 on a surface of the beverage container 10. The display device 68 may be electronically connected to the processing unit 54 through the I/O port 62.

An application on the user's mobile device may indicate a current fluid level and/or track the user's consumption of fluid from the beverage container 10 and display results to the user. The application may provide additional fluid level notifications such as notifying the user that it is “time to drink more water”, or indicating the user's progress level toward a goal (e.g., percentage accomplished of a daily fluid consumption goal). The application may also provide other indications such as the temperature measurements of the air or fluid in the beverage cavity 12, or notifications regarding the power level of the batteries 26. The application may track consumption over time and display statistics regarding fluid consumption. The application may cause the mobile device to send data to the communication unit 64 for processing and analysis related to fluid level determination.

The beverage container 10 may implement one or more features for power management and/or conservation. The electronic system 18 may implement a sampling schedule that allows for conservation of power and battery life. When the beverage container 10 is not in use or the electronic system 18 determines that the user has not recently or is not currently consuming fluid from the beverage container, the electronic system may maintain the beverage container 10 in a low power state where some electronic components (e.g., the ADC 52, the DSP 60, the communication unit 64) are maintained in a sleep state or receive a reduced supply of power. The communication unit 64, for example, may not transmit any wireless communications in the sleep state. In another non-limiting example, the processing unit 54 may control the ADC 52 to sample the audio signal from the audio system component 40 in response to receiving an indication that the user recently consumed or is currently consuming fluid from the beverage container 10.

The electronic system 18 may monitor sensors to determine whether the beverage container is in use or the user is or has recently consumed fluid from the beverage container 10. In some embodiments, the electronic system 18 may use the motion sensing system component 42 to determine when to take a sample. The motion sensing system component 42 may include an accelerometer and associated electronics that produce a signal indicating motion or tilting when the beverage container 10 is moved upwards or tilted at an angle. During periods when no upward or tilting motion is detected, there is likely no need to sample since it is unlikely that the user has consumed any fluid. The electronic system 18 in some embodiments may monitor the status of the cap 37 to determine when to sample sound in the beverage cavity 12. The lid 20 may include a contact switch or noncontact switch, such as a magnetic reed switch, that detects the presence or absence of the cap 37 on the lid or the drinking aperture 38. If the cap 37 is detected positioned on the lid 20 or the drinking aperture 38, the electronic system 18 may be maintained in the low-power state. The electronic system 18 may be wakened from the low-power state when the cap 37 is removed from the lid 20 or the drinking aperture 38.

Other methods and configurations for detecting user consumption of fluid from the beverage cavity are contemplated. The audio signal may be monitored to determine whether the cap 37 is on the lid 20 or the drinking aperture 38. Specifically, the absence of a resonant peak in the audio signal may indicate that the cap 37 is on because Helmholtz resonance requires an open the beverage cavity 12 (i.e., drinking aperture 38 is opened). The amplitude of the audio signal may be monitored to determine whether the cap 37 is on. When the amplitude of the audio signal is lower than a predetermined threshold, for example, the electronic system 18 may be maintained in the low-power state because it is more likely to be quieter inside the beverage cavity when the 37 is on. Partial samples may be taken, and if the cap is the 37 is detected on the lid 20, the electronic system 18 could move into sleep mode, or discontinue transmissions from the communication unit 64. In another method or configuration, the lid 20 may use two or more accelerometers to sense inertia of the beverage container 10 and thereby determine when the user picks up and consumes from the beverage container. In a further method or configuration, the lid 20 may include a capacitive sensor installed at or near the drinking aperture 38 for detecting fluid consumption. The electronic system 18 may be electronically coupled to the capacitive sensor and configured to detect user fluid consumption when fluid in the beverage cavity 18 contacts the capacitive sensor. The electronic system 18 may include one or more accelerometer in addition to the capacitive sensor to improve accuracy in detecting user fluid consumption.

The beverage container 10 may include the sound generating unit 50 for actively producing and/or controlling noise within the beverage cavity 12. The sound generating unit 50 may comprise a speaker positioned within or directed into the beverage cavity 12. Beverage containers in the 12 oz. to 36 oz. capacity range may produce resonant tones having an expected signal band of resonant frequencies f_{R} from empty to full between 100 Hz and 1 kHz (frequency becomes lower as fluid level in beverage cavity 12 decreases). The sound generating unit 50 produces a controlled sound that contains all frequencies in the expected signal band. Ambient outside noise from the environment may include out-of-band frequencies and monotonic tones that adversely influence or interfere with measurement of the resonant frequency in the beverage cavity 12. The sound generating unit 50 introduces controlled noise that excites resonance, eases extraction of the resonant response, and increases the SNR in the system.

The sound generating unit 50 may be part of the audio system component 40, as shown in FIG. 3B. The sound generating unit 50 may be electronically coupled to the processing unit 54 via the I/O port 62 and configured to generate the controlled sound having the expected signal band in response to receiving a control signal from the processing unit. The sound generating unit 50 may produce the controlled sound based on a sound output signal sent from the processing unit 54, or the sound generating unit 50 may be preprogrammed to produce the controlled sound. The sound generating unit 50 may be controlled to periodically produce the controlled sound, or produce the controlled sound only in response to a predetermined stimulus, such as opening of the drinking aperture 38. The sound generating unit 50 may be powered off when the beverage container 10 is in the low-power state described above.

The controlled sound produced by the sound generating source 50 may include white noise, pink noise, red noise, or may be a frequency sweep. White noise would contain all the frequencies in the expected signal band. Pink noise has an equal energy level per octave, resulting in less high-frequency components than white noise, which is appealing given the low frequency band of the expected signal. Red noise is random noise that decreases in energy per octave, resulting in even fewer high-frequency components than pink noise, which is also appealing given the low frequency band of the expected signal. A frequency sweep would play tones ranging across the entire signal band (e.g., from 100 Hz to 1 kHz), one tone at a time. Using the frequency sweep may not require processing the measured audio signal using a Fourier transform, as the signal could be monitored for amplitude. Specifically, the resonant frequency f_{R} would have a higher amplitude when the frequency sweeps through the resonant point, which the processing unit 54 could detect during or contemporaneous to the frequency sweep. The sound generating unit 50 could play other tones or sounds that provide benefit in terms of SNR and also enhance user experience (for example, a “whooshing wave” sound or a “water droplet” sound).

The beverage container 10 may generate a sound impulse (e.g., “click”, “snap”) containing all the frequencies in the expected signal band when the cap 37 is removed from the drinking aperture 38. The sound impulse may be mechanically-generated by a feature integrated into the lid 20 such that, as the cap is removed from the drinking aperture 38, a part of the cap interacts with the feature to produce the sound impulse. The sound impulse may be electronically-generated by an electromechanical device, such as a solenoid or linear actuator, which generates the sound impulse when the cap 37 is removed.

The lid 20 may interchangeable with a variety of types, sizes and/or shapes of container main bodies 32. The lid 20 may be configured to automatically determine the size and/or shape of the beverage cavity 12 by receiving information regarding the type of container main body 32, or the lid may provide information identifying the size and/or shape of the beverage cavity based on user input. The electronic system 18 may accurately determine the fluid level in the beverage cavity 12 based on the size and/or shape of the beverage cavity identified. The electronic system 18 may reference calibration curves or look-up tables in the memory 58 based on the information received when determining the fluid level to reduce load on the processing unit 54.

In some embodiments, the communication unit 64 may receive information relating to the size and/or shape of the container main body 32 and use the information when determining the fluid level of fluid in the beverage cavity 12. Each container main body 32 may include an identification unit such as a radio frequency identification device (RFID) that transmits a low power wireless identification signal containing information from which the electronic system 18 may identify the type, size and/or shape of the container main body 32. Alternatively, the user may interact with the application on the mobile device to identify the type of container main body 32 that is attached to the lid 20, and transmit information to the electronic system 18 that helps it to identify the size, shape and/or type of the beverage cavity 12.

In other embodiments, each container main body 32 may include an electronic component (e.g., resistor, capacitor, IC) that is electronically coupled to the electronic system 18 when the lid 20 is attached to the container main body. The lid 20 may have an electrical contact that interfaces with an electric contact on the container main body 32 when the lid is attached thereto. When the lid 20 is attached to the container main body 32, the electronic component of the container main body may complete an electrical circuit of the electronic system 18, such as an oscillator, or send an electronic signal to the electronic system. The electronic system 18 may identify the type, size and/or shape of the container main body 32 based on the response from the completed electrical circuit or the signal received.

Measurements of the audio signal may be repeated to improve confidence. A plurality of audio signals may be sampled and then averaged to improve SNR. The measurements may be repeated so as to improve confidence in the extraction of the resonant peak.

The beverage container described herein has numerous benefits over previously-implemented methods and devices for measuring the fluid level of a fluid in the beverage container. The beverage container described above has the benefits of very low power consumption and very low cost. Measurement of the fluid level is insensitive to beverage container tilt and motion. The beverage container may use ambient environmental sound and does not require an active noise source to measure the fluid level therein, and is immune to outside influence.

What is claimed is:

1. A lid for a beverage container, the lid comprising:
a lid main body configured to be removably attached to a beverage container;
a sensor, contained in the lid main body, configured to measure sound waves;
a processor, contained in the lid main body, electronically coupled to the sensor; and
memory electrically coupled to the processor and provided with code that, when executed by the processor, causes the processor to:
receive a measurement of the sound waves from the sensor;
obtain a frequency characteristic of the sound waves based at least in part on the measurement;
obtain reference information regarding one or more characteristics of the beverage container and one or more characteristics of the lid main body; and
determine a volume of air based at least in part on the frequency characteristic and the reference information.

2. The lid of claim 1, wherein obtaining the frequency characteristic comprises causing a frequency-domain analysis to be performed on the measurement.

3. The lid of claim 2, wherein the frequency characteristic obtained is a resonant frequency determined as a result of performing the frequency-domain analysis.

4. The lid of claim 1, wherein the lid main body includes a drinking aperture, and the reference information regarding the one or more characteristics of the lid main body comprises information regarding the drinking aperture.

5. The lid of claim 1, wherein the code, when executed by the processor, further causes the processor to cause provision of a notification to a user of the lid regarding a level of liquid based at least in part on the volume of air.

6. The lid of claim 1, wherein the volume of air is determined based on a calculation performed using a resonant frequency analysis.

7. A method for determining a level of liquid in a beverage container, the method comprising:
receiving a measurement, from an acoustic sensor installed in a beverage container lid, of sound waves in a beverage container;
obtaining a frequency characteristic of the measurement;
obtaining reference information regarding characteristics of at least one of the beverage container and the beverage container lid; and
determining a volume of air in the beverage container based at least in part on the reference information and the frequency characteristic.

8. The method of claim 7, wherein the reference information includes information regarding an empty volume of the beverage container, the method further comprising:
determining a level of liquid contained in the beverage container at least performing an analysis regarding the volume of air in relation to the empty volume of the beverage container of the reference information.

9. The method of claim 8, the method further comprising:
providing a notification regarding the level of liquid in the beverage container.

10. A beverage container assembly comprising:
a beverage container main body having a cavity for holding a liquid;
a lid configured to be removably attached to the beverage container main body over the cavity;
a sensor configured to measure sound waves in the beverage container main body;
a processor electronically coupled to the sensor; and
memory electrically coupled to the processor and provided with code that, when executed by the processor, causes the processor to:
receive a measurement of the sound waves from the sensor;
obtain a frequency characteristic of the sound waves based at least in part on the measurement;
obtain reference information regarding one or more characteristics of the beverage container main body and one or more characteristics of the lid; and
determine a volume of air based at least in part on the frequency characteristic and the reference information.

11. The beverage container assembly of claim 10, wherein the beverage container main body comprises an electronic component configured to provide information regarding the beverage container main body.

12. The beverage container assembly of claim 11, wherein the electronic component is electrically coupled to the processor as a result of the lid being attached to the beverage container main body, and the reference information retrieved is based at least in part on the information regarding the beverage container main body.
